(19) United States
(12) Patent Application Publication
(10) Pub. No.: US 2019/0380547 A1
(43) Pub. Date: Dec. 19, 2019

(54) STAIR DEBRIS ACCUMULATION FOR AUTOMATIC CLEANING DEVICES

(71) Applicant: QUALCOMM Incorporated, San Diego, CA (US)

(72) Inventors: Matthew Hyatt Turpin, Philadelphia, PA (US); Travis Van Schoyck, Princeton, NJ (US); Ross Eric Kessler, Philadelphia, PA (US); Michael Joshua Shomin, Philadelphia, PA (US); Paul Daniel Martin, Philadelphia, PA (US); Rizwan Ahmed, Haddonfield, NJ (US); Moussa Ben Coulibaly, Brookhaven, PA (US); Kristen Wagner Cerase, Newark, DE (US)

(21) Appl. No.: 16/007,891

(22) Filed: Jun. 13, 2018

(51) Int. Cl. A47L 5/14; A47L 11/40; G05D 1/00; G05D 1/10; B64C 39/02

(52) U.S. Cl. CPC A47L 5/14; A47L 11/4027; G05D 1/0088; G05D 1/101; B64C 2201/141; A47L 2201/04; A47L 2201/06; G05D 2201/0203; B64C 2201/108; B64C 39/024

(57) ABSTRACT

Methods, systems, and devices for debris permutation are described. A robotic device may identify a cleaning trigger for a first surface region (e.g., a cleaning schedule, a notification from a remote device). The robotic device may activate one or more rotors o based at least in part on the surface cleaning trigger and move to an aerial position proximal to (e.g., above, diagonal to) the first surface region using the one or more rotors. The device may displace debris from the first surface region to a second surface region using a pressurized air stream.

### BACKGROUND

The following relates generally to debris permutation, and more specifically to stair debris accumulation for automatic cleaning devices.

Robotic devices have become increasingly commonplace for performing various tasks in a semi-autonomous or autonomous manner. Such robotic devices may be embodied in a variety of forms and used in a variety of applications, such as in automated vacuum cleaners, unmanned aerial vehicles, terrestrial vehicle, etc. Applications for which robotic devices may be employed may include entertainment applications (e.g., toy robots), utility applications in environments that are unfriendly to humans (e.g., space, deep water, cold temperature, radiation, chemical exposure, biohazards, etc.), dangerous tasks (e.g., defusing of explosives), operation in confined spaces (e.g., collapsed buildings), performance of menial tasks (e.g., cleaning), etc.

### SUMMARY

The described techniques relate to improved methods, systems, devices, and apparatuses that support stair debris accumulation for automatic cleaning devices. Generally, the described techniques provide for an aerial device that supports debris accumulation. Some areas of an environment may be difficult for a robotic vacuum to access independently. Examples of such areas include stairs, corners, elevated surfaces (e.g., desks, counters, etc.), crevices, etc. In accordance with aspects of the present disclosure, an aerial device may displace debris from a first surface region to a second surface region that is more accessible for a robotic vacuum. For example, the aerial device may identify a cleaning trigger (e.g., a scheduled cleaning, an amount of debris, a notification received from another device) for the first surface region and may perturb debris located in the first surface region. The aerial device may move using one or more rotors. In some cases, the debris perturbation may be based at least in part on the one or more rotors (e.g., on a thrust vector produced by the rotors). In some cases, the aerial device may perform multiple passes over the first surface region (e.g., a configured number of passes, a number of passes until the first surface region satisfies a debris threshold). The aerial device may in some cases include one or more filters for removing debris from the air.

A method of debris perturbation by an aerial device is described. The method may include identifying a cleaning trigger for a first surface region, activating one or more rotors of the aerial device based on the surface cleaning trigger, moving to an aerial position proximal to the first surface region using the one or more rotors, and displacing debris from the first surface region to a second surface region using a pressurized air stream.

An apparatus for debris perturbation is described. The apparatus may include a processor, memory in electronic communication with the processor, and instructions stored in the memory. The instructions may be executable by the processor to cause the apparatus to identify a cleaning trigger for a first surface region, activate one or more rotors of the aerial device based on the surface cleaning trigger, move to an aerial position proximal to the first surface region using the one or more rotors, and displace debris from the first surface region to a second surface region using a pressurized air stream.

Another apparatus for debris perturbation is described. The apparatus may include means for identifying a cleaning trigger for a first surface region, activating one or more rotors of the aerial device based on the surface cleaning trigger, moving to an aerial position proximal to the first surface region using the one or more rotors, and displacing debris from the first surface region to a second surface region using a pressurized air stream.

A non-transitory computer-readable medium storing code for debris perturbation by an aerial device is described. The code may include instructions executable by a processor to identify a cleaning trigger for a first surface region, activate one or more rotors of the aerial device based on the surface cleaning trigger, move to an aerial position proximal to the first surface region using the one or more rotors, and displace debris from the first surface region to a second surface region using a pressurized air stream.

In some examples of the method, apparatuses, and non-transitory computer-readable medium described herein, identifying the cleaning trigger for the first surface region may include operations, features, means, or instructions for detecting a debris level for the first surface region using one or more sensors, comparing the debris level to a debris collection threshold and activating the one or more rotors based on the comparing.

In some examples of the method, apparatuses, and non-transitory computer-readable medium described herein, the one or more sensors include a set of infrared beacons.

In some examples of the method, apparatuses, and non-transitory computer-readable medium described herein, moving to the aerial position proximal to the first surface region may include operations, features, means, or instructions for moving along an aerial path proximal to the first surface by adjusting a trajectory of at least one rotor.

Some examples of the method, apparatuses, and non-transitory computer-readable medium described herein may further include operations, features, means, or instructions for performing a set of traversals of the aerial path and detecting a debris level for the first surface region using one or more sensors after each traversal, where a final traversal of the set of traversals may be based on the corresponding debris level.

In some examples of the method, apparatuses, and non-transitory computer-readable medium described herein, displacing debris from the first surface region using the pressurized air stream may include operations, features, means, or instructions for directing a thrust from at least one rotor toward the first surface region.

Some examples of the method, apparatuses, and non-transitory computer-readable medium described herein may further include operations, features, means, or instructions for determining a height of the aerial position relative to the first surface region, where a thrust vector of the pressurized air stream may be based on the height.

In some examples of the method, apparatuses, and non-transitory computer-readable medium described herein, identifying the cleaning trigger for the first surface region may include operations, features, means, or instructions for identifying an activation interval corresponding to a periodic activation schedule.

In some examples of the method, apparatuses, and non-transitory computer-readable medium described herein, identifying the cleaning trigger for the first surface region may include operations, features, means, or instructions for receiving an activation signal from another device.

In some examples of the method, apparatuses, and non-transitory computer-readable medium described herein, the first surface may be co-planar with the second surface and where the first surface may be adjacent to one or more vertical structures.

In some examples of the method, apparatuses, and non-transitory computer-readable medium described herein, the first surface may be vertically displaced from the second surface.

### BRIEF DESCRIPTION OF THE DRAWINGS

FIG. 1 illustrates an example of a system for debris permutation that supports stair debris accumulation for automatic cleaning devices in accordance with aspects of the present disclosure.

FIG. 2 illustrates an example of an operating environment that supports stair debris accumulation for automatic cleaning devices in accordance with aspects of the present disclosure.

FIG. 3 illustrates an example of a debris removal system that supports stair debris accumulation for automatic cleaning devices in accordance with aspects of the present disclosure.

FIG. 4 illustrates an example of an operating environment that supports stair debris accumulation for automatic cleaning devices in accordance with aspects of the present disclosure.

FIG. 5 shows a block diagram of a device that supports stair debris accumulation for automatic cleaning devices in accordance with aspects of the present disclosure.

FIG. 6 shows a diagram of a system including a device that supports stair debris accumulation for automatic cleaning devices in accordance with aspects of the present disclosure.

FIGS. 7 through 10 show flowcharts illustrating methods that support stair debris accumulation for automatic cleaning devices in accordance with aspects of the present disclosure.

### DETAILED DESCRIPTION

Some operating environments (e.g., homes, office spaces, warehouses) may be maintained based at least in part on one or more robotic devices (e.g., robotic vacuums). For example, such robotic devices may be associated with debris removal, security, mapping, etc. Some such operating environments may include one or more regions that are inaccessible to the robotic device (e.g., corners, stairs, shelves). Aspects of the present disclosure relate to techniques for improving maintenance of such regions. For example, an aerial device operating in accordance with aspects of the present disclosure may perturb debris from such regions, where the debris perturbation may move the debris from the difficult-to-access region(s) to regions that are more accessible for a robotic vacuum. In some cases locomotion of the aerial device and perturbation of the debris may be based on rotors of the aerial device. For example, the rotors may provide lift and maneuverability for the aerial device. In some cases, the thrust from the rotors may be funneled or otherwise directed to create a pressurized air stream for perturbing the debris. The aerial device may in some cases represent a device that supports wireless communications with other devices (e.g., control panels, the robotic vacuum, mobile devices). In some cases, the aerial device may perform the debris perturbation operations based in part on an indication received from another device. Additionally or alternatively, the debris perturbation operations may be performed in accordance with a schedule (e.g., at a certain time of day), based on sensory input (e.g., an amount of debris detected).

Aspects of the disclosure are initially described in the context of an operating environment. Aspects of the disclosure are further illustrated by and described with reference to apparatus diagrams, system diagrams, and flowcharts that relate to stair debris accumulation for automatic cleaning devices.

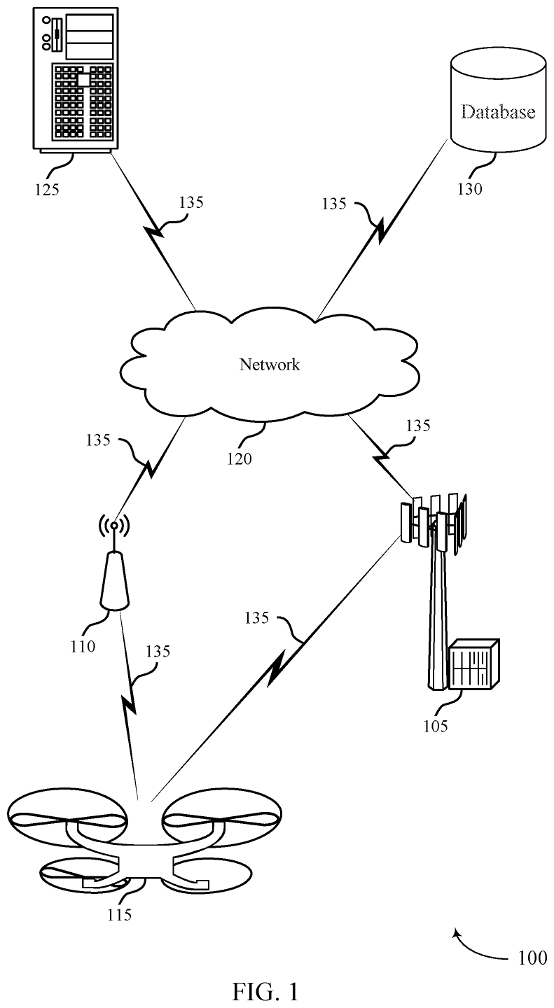

FIG. 1 illustrates an example of a system 100 that supports a robotic device 115 operating in support of stair debris accumulation in accordance with aspects of the present disclosure. The term “robotic device” may be used herein to describe one of various types of robotic vehicles, robotic appliances, robots, etc. including an onboard processing device configured to provide some autonomous or semi-autonomous capabilities. Examples of robotic devices 115 include aerial vehicles, such as an unmanned aerial vehicle (UAV). In some examples, the robotic device 115 may be operated manually. In some examples, the robotic device 115 may operate autonomously.

In examples in which the robotic device 115 is autonomous, the robotic device 115 may include an onboard processing device configured to maneuver and/or navigate the robotic device 115 without remote operating instructions (i.e., autonomously), such as from a human operator (e.g., via a remote computing device). In examples in which the robotic device 115 is semi-autonomous, the robotic device 115 may include an onboard processing device configured to receive some information or instructions, such as from a human operator (e.g., via a remote computing device) and autonomously maneuver the robotic device 115 in accordance with the received information or instructions.

The term “position” may be used herein to describe a location and an orientation of the robotic device 115 within a geo-boundary. In an example in which the robotic device 115 navigates in two-dimensions (2D), such as along the surface of a floor, the position of the robotic device 115 may be specified by a 2D position (x,y) and a heading (0). In an example in which the robotic device 115 navigates in three-dimensions (3D), such as in an aerial space, the position of the robotic device 115 may be defined based on a 3D position (x,y,z). In some embodiments, the robotic device 115 may employ simultaneous localization and mapping (SLAM) techniques to construct and update a map of an environment and geo-boundary associated with the environment, while simultaneously keeping track of its position within the environment and relative to the geo-boundary. A geo-boundary may correspond to a premises and define a 2D or 3D spatial boundary associated with the environment. For example, an environment may be a premises including a home, and the geo-boundary may correspond to certain zones (e.g., rooms) of the home that the robotic device 115 is allowed to perform autonomous functions while other zones may be restricted (e.g., rooms where the robotic device 115 is not allowed to perform autonomous functions).

The system 100 may include the robotic device being configured to perform an autonomous debris collection process. For example, the robotic device 115 may agitate debris within an operating environment (e.g., and may remove such debris in some examples). The robotic device 115 may be configured to move between surfaces within a 3D geo-boundary in coordination with a robotic vacuum. For example, the robotic device 115 may identify a location of a first surface region and may move debris from the first surface region to a second surface region within the 3D geo-boundary.

In some examples, the robotic device 115 may employ various mechanisms and algorithms for determining a path within a geo-boundary to navigate to a designated area (e.g., an aerial position). The designated area may be user-defined (e.g., pre-configured) and/or identified by the robotic device 115 using sensory data related to the environment. After identifying the location, the robotic device 115 may move around (e.g., along an aerial path) to perturb debris. The robotic device 115 may also be capable of generating and transmitting a notification message indicating its location, such that an individual may locate the robotic device 115.

The system 100 may also include a base station 105, an access point 110, a server 125, and a database 130. The server 125 may include any combination of a data server, a cloud server, a server associated with an automation service provider, proxy server, mail server, web server, application server, database server, communications server, home server, mobile server, or any combination thereof. For example, the robotic device 115 may upload data (e.g., notifications) to an application hosted by the server 125 for posting data related to autonomous functions performed by the robotic device 115. For example, a user may be able to view the data posted by the robotic device 115 via an application running on a personnel wireless device to review functions performed by the device 115. The server 125 may also transmit to the robotic device 115 a variety of information, such as navigation information, movement control instructions, and other information, instructions, or commands relevant to autonomous operations of the robotic device 115.

The database 130 may store data that may include navigation information, movement control instructions, and other information, instructions, or commands (e.g., track locations, occupancy data, administrator preferences) relevant to autonomous operations of the robotic device 115. The robotic device 115 may retrieve the stored data from the database via the base station 105 and/or the access point 110.

The network 120 that may provide encryption, access authorization, tracking, Internet Protocol (IP) connectivity, and other access, computation, modification, and/or functions. Examples of network 120 may include any combination of cloud networks, local area networks (LAN), wide area networks (WAN), virtual private networks (VPN), wireless networks (using 802.11, for example), cellular networks (using third generation (3G), fourth generation (4G), long-term evolved (LTE), or new radio (NR) systems (e.g., fifth generation (5G)) for example), etc. Network 120 may include the Internet.

The base station 105 may wirelessly communicate with the robotic device 115 via one or more base station antennas. Base station 105 described herein may include or may be referred to by those skilled in the art as a base transceiver station, a radio base station, an access point, a radio transceiver, a NodeB, an eNodeB (eNB), a next-generation Node B or giga-nodeB (either of which may be referred to as a gNB), a Home NodeB, a Home eNodeB, or some other suitable terminology. The robotic device 115 described herein may be able to communicate with various types of base stations and network equipment including macro eNBs, small cell eNBs, gNBs, relay base stations, and the like. The access point 110 may be configured to provide wireless communications for the robotic device 115 over a relatively smaller area compared to the base station 105.

In some cases, the robotic device 115 may also be able to communicate directly with another device (e.g., using a peer-to-peer (P2P) or device-to-device (D2D) protocol) such as: a user equipment (UE), a user device, a smartphone, a BLUETOOTH® device, a Wi-Fi device, a mobile station, a subscriber station, a mobile unit, a subscriber unit, a wireless unit, a remote unit, a mobile device, a wireless device, a wireless communications device, a remote device, an access terminal, a mobile terminal, a wireless terminal, a remote terminal, a handset, a user agent, a mobile client, a client, and/or some other suitable terminology.

The wireless communication links 135 shown in the system 100 may include uplink (UL) transmissions from the robotic device 115 to the base station 105, the access point 110, or the server 125, and/or downlink (DL) transmissions, from the base station 105, the access point 110, or the server 125 to the robotic device 115. The downlink transmissions may also be called forward link transmissions while the uplink transmissions may also be called reverse link transmissions. The wireless communication links 135 may transmit bidirectional communications and/or unidirectional communications. Wireless communication links 135 may include one or more connections, including but not limited to, 345 MHz, Wi-Fi, BLUETOOTH®, BLUETOOTH® Low Energy, cellular, Z-WAVE®, 802.11, peer-to-peer, LAN, wireless local area network (WLAN), Ethernet, FireWire®, fiber optic, and/or other connection types related to wireless communication systems.

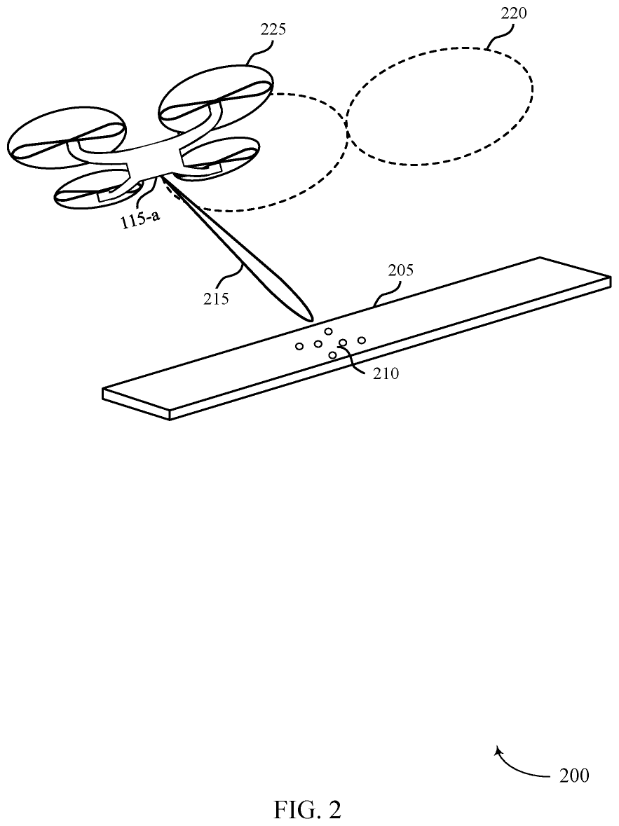

FIG. 2 illustrates an example of an operating environment 200 that supports stair debris accumulation for automatic cleaning devices in accordance with aspects of the present disclosure. The operating environment 200 includes a robotic device 115-a, which may be an example of a robotic device 115 (e.g., an aerial device) as described with reference to FIG. 1. Robotic device 115-a may in some cases support maintenance of one or more surfaces 205 (e.g., surfaces 205 which may be inaccessible to a robotic vacuum). For example, robotic device 115-a may displace debris 210 from surface 205 to another surface that is accessible to the robotic vacuum.

In some examples, operating environment 200 may be a home, an office, a staircase, or any other environment that includes one or more surfaces 205 that have different accessibilities for a robotic vacuum. In some examples, operating environment 200 may be maintained by a ground-based device that moves through operating environment 200 in a horizontal manner (e.g., a robotic vacuum). Surfaces within operating environment 200 (e.g., surface 205) may be examples of hardwood floors, tile floors, carpeted floors, etc.

In some examples, robotic device 115-a may navigate operating environment 200 to support the functionality of a robotic vacuum. The robotic device 115-a may be configured with mapping techniques allowing it to construct a map of its surroundings (e.g., the operating environment 200). In addition, the robotic device 115-a may be configured to localize itself within the map, and thereby support a degree of autonomy when performing functions within the operating environment 200. In some embodiments, the robotic device 115-a may identify a geo-boundary (e.g., a 2D and/or 3D geo-boundary) corresponding to the operating environment 200.

The operating environment 200 may be, in some examples, part of a structure, such as a residential or commercial building. For example, operating environment 200 may be a home and each surface 205 may be or include a room (e.g., bedroom, living room) or portion thereof including one or more access points (e.g., windows and/or doors) and objects (e.g., furniture, electronic devices) spread throughout the room. The geo-boundary may relate to the operating environment 200 and the robotic device 115-a may be configured to perform autonomous functions within the geo-boundary. For example, the robotic device 115-a may support an autonomous debris collection process within the operating environment 200.

Robotic device 115-a may include one or more rotors 225 which may be used by to move around operating environment 200 (e.g., along aerial path 220). For example, aerial path 220 is illustrated as having the shape of a figure-eight, and robotic device 115-a may move along aerial path 220. It is to be understood that aerial path 220 may be or include any path shape (e.g., a regular shape, an irregular shape) without deviating from the scope of the present disclosure. In some cases, robotic device 115-a may produce a pressurized air stream 215 which may dislodge debris 210 from surface 205 to a second surface for collection by a robotic vacuum. Robotic device 115-a may determine to move about operating environment 200 according to aerial path 220. In some cases, aerial path 220 may represent a preconfigured route for displacing debris 210 from elevated surfaces 205 of operating environment 200. In some cases, robotic device 115-a may determine to move about operating environment 200 based on sensor information that indicates the location of debris 210. For example, robotic device 115-a may include various sensors that detect debris 210 on surface 205, and robotic device 115-a may move to an aerial position above the surfaces 205 on which debris 210 is detected.

Robotic device 115-a may determine to move about operating environment 200 according to time and/or date information. For example, robotic device 115-a may determine that a certain time of day correlates with a greater debris build up than other times of the day (e.g., corresponding to a time of day when users of operating environment 200 frequently enter and exit the premises). Similarly, robotic device 115-a may determine that different months (e.g., or seasons) of the year correlate with a greater debris build up than other periods of the year. Robotic device 115-a may thus adjust its movement patterns within operating environment 200 according to such time and/or date information (e.g., may adjust aerial path 220, may traverse aerial path 220 more frequently).

In some embodiments, the robotic device 115-a may be equipped with any of a number of additional sensors useful for SLAM and navigation, such as wheel/rotary encoders, a global navigation satellite system (GNSS) receiver (e.g., a Global Positioning System (GPS) receiver), an inertial measurement unit (IMU) or components thereof (e.g., accelerometer, gyroscope, magnetometer, etc.), an orientation sensor, and a monocular image sensor.

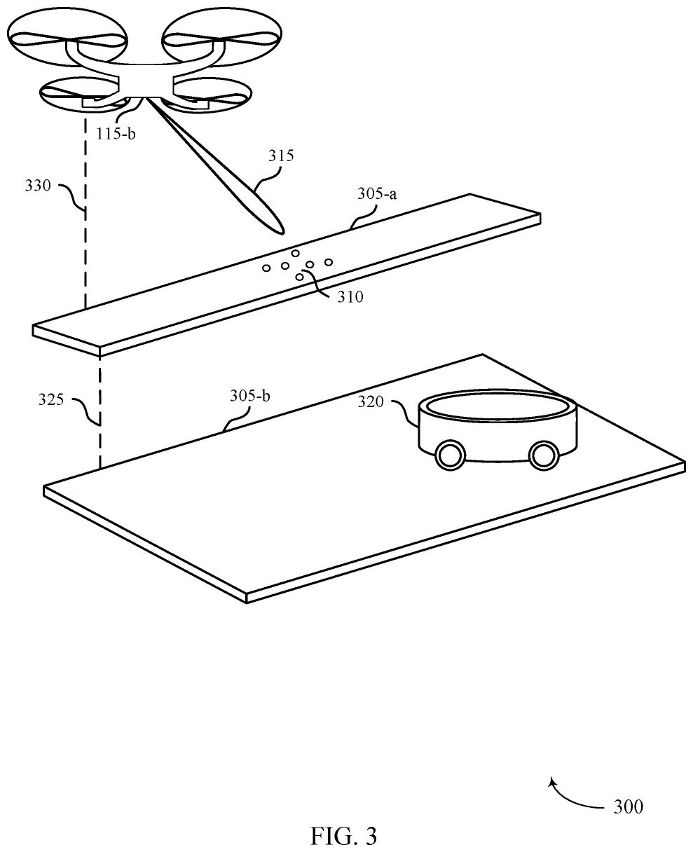

FIG. 3 illustrates an example of a debris removal system 300 that supports stair debris accumulation for automatic cleaning devices in accordance with aspects of the present disclosure. Debris removal system 300 may represent aspects of operating environment 200 as described with reference to FIG. 2. For example, debris removal system 300 may include a robotic device 115-b, which may be an example of the corresponding device described with reference to FIGS. 1 and 2.

Debris removal system 300 may include a first surface 305-a, which is vertically displaced from surface 305-b by vertical distance 325. Further, surface 305-a and surface 305-b may not be connected by a surface that can be navigated by a robotic vacuum 320 (e.g., a ramp). Thus, due to its mobility characteristics, robotic vacuum 320 may be unable to access surface 305-a without external assistance. Therefore, the operational effectiveness of the robotic vacuum 320 may be limited.

In some examples, debris 310 may be located on surface 305-a. Robotic device 115-a may move to an aerial position proximal to (e.g., above) surface 305-a and may generate a pressurized air stream 315 using one or rotors (e.g., or similar components) of the robotic device 115-b. Pressurized air stream 315 may dislodge debris 310 from surface 305-a to surface 305-b. After robotic device 115-b displaces debris 310 from surface 305-a to surface 305-b, robotic vacuum 320 may be able to collect debris 310. In some cases, robotic device 115-b may make multiple passes over surface 305-a in order to more thoroughly dislodge and displace debris. As described above with reference to FIG. 2, robotic device 115-b may determine a pattern of movement within based on a preconfigured pattern, sensor information, or time and/or date information, for example.

In some cases, robotic device 115-b may move to an aerial position that is proximal to (e.g., above) surface 305-a. For example, the aerial position may be a height 330 above surface 305-a. In some cases, height 330 may be determined autonomously or may be based at least in part on preconfigured information. In some examples, the force (e.g., thrust, pressure) of pressurized air stream 315 may be based at least in part height 330. For example, robotic device 115-b may generate a stronger pressurized air stream 315 for larger heights 330.

In some examples, pressurized air stream 315 may be generated by one or more rotors of robotic device 115-b. In some such examples, robotic device 115-b may include a funneling system for directing a thrust from the one or more rotors towards surface 305-a. Additionally or alternatively, robotic device 115-b may include a separate component (e.g., an internal rotor or the like) for generating pressurized air stream 315.

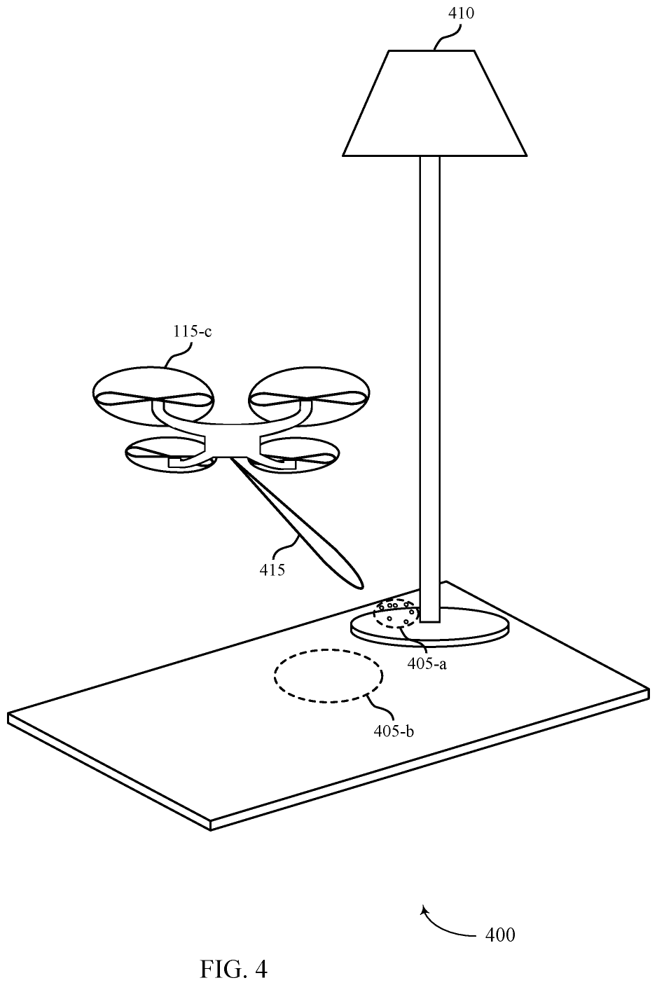

FIG. 4 illustrates an example of an operating environment 400 that supports stair debris accumulation for automatic cleaning devices in accordance with aspects of the present disclosure. Operating environment 400 may represent aspects of operating environment 200 or debris removal system 300. For example, operating environment 400 includes a robotic device 115-c, which may be an example of the corresponding device described with reference to FIGS. 1, 2, and 3.

In some examples, operating environment 400 may include an obstacle 410. Obstacle 410 may be an example of a lamp, a chair, a couch, or any other object which may gather debris in a manner that is not collectible by a robotic vacuum. For example, obstacle 410 may be a lamp whose base has gathered debris. The dimensions of the base may prevent a robotic vacuum from collecting the debris on the base.

Robotic device 115-c may hover near obstacle 410 (e.g. at an aerial position above a base of obstacle 410) and produce a pressurized air stream 415 that dislodges debris from a first surface region 405-a (e.g., including the base of obstacle 410). In some cases, first surface region 405-a may include a corner of a room or an area that is otherwise inaccessible to a robotic vacuum (e.g., because of obstacle 410). Robotic device 115-c may displace debris to a second surface region 405-b surface (e.g., a floor below the base of obstacle 410) from which a robotic vacuum may collect the debris.

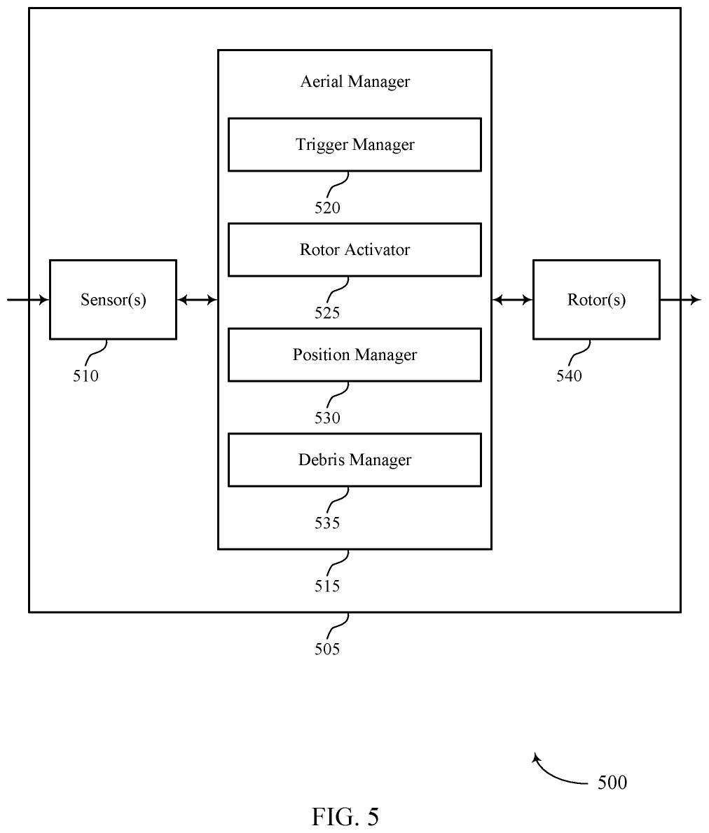

FIG. 5 shows a block diagram 500 of a device 505 that supports stair debris accumulation for automatic cleaning devices in accordance with aspects of the present disclosure. The device 505 may be an example of aspects of a robotic device as described herein. The device 505 may include sensor(s) 510, an aerial manager 515, and rotor(s) 540. The device 505 may also include a processor. Each of these components may be in communication with one another (e.g., via one or more buses).

The aerial manager 515 may be an example of aspects of the aerial manager 610 described herein. The aerial manager 515 may include a trigger manager 520, a rotor activator 525, a position manager 530, and a debris manager 535. Each of these modules may communicate, directly or indirectly, with one another (e.g., via one or more buses). The aerial manager 515, or its sub-components, may be implemented in hardware, code (e.g., software or firmware) executed by a processor, or any combination thereof. If implemented in code executed by a processor, the functions of the aerial manager 515, or its sub-components may be executed by a general-purpose processor, a DSP, an application-specific integrated circuit (ASIC), a FPGA or other programmable logic device, discrete gate or transistor logic, discrete hardware components, or any combination thereof designed to perform the functions described in the present disclosure.

The aerial manager 515, or its sub-components, may be physically located at various positions, including being distributed such that portions of functions are implemented at different physical locations by one or more physical components. In some examples, the aerial manager 515, or its sub-components, may be a separate and distinct component in accordance with various aspects of the present disclosure. In some examples, the aerial manager 515, or its sub-components, may be combined with one or more other hardware components, including but not limited to an input/output (I/O) component, a transceiver, a network server, another computing device, one or more other components described in the present disclosure, or a combination thereof in accordance with various aspects of the present disclosure.

Device 505 may be equipped with at least one spatial measurement device (e.g., sensors 510), such as an imaging sensor (e.g., a camera). In some embodiments, device 505 may be equipped with any of a number of additional sensors useful for SLAM and navigation, such as wheel/rotary encoders, a GNSS receiver (e.g., a GPS receiver), an IMU or components thereof (e.g., accelerometer, gyroscope, magnetometer, etc.), an orientation sensor, and a monocular image sensor. In some cases, the one or more sensors 510 of the device include infrared beacons.

The trigger manager 520 may identify a cleaning trigger for a first surface region.

In some examples, the trigger manager 520 may detect a debris level for the first surface region using sensor(s) 510. In some examples, the trigger manager 520 may compare the debris level to a debris collection threshold. In some examples, the trigger manager 520 may activate the one or more rotors based on the comparing. In some examples, the trigger manager 520 may detect a debris level for the first surface region using one or more sensors after each traversal, where a final traversal of the set of traversals is based on the corresponding debris level. In some examples, the trigger manager 520 may identify an activation interval corresponding to a periodic activation schedule. In some examples, the trigger manager 520 may receive an activation signal from another device.

The position manager 530 may move to an aerial position proximal to the first surface region using the one or more rotors. In some examples, the position manager 530 may move along an aerial path proximal to the first surface by adjusting a trajectory of at least one rotor. In some examples, the position manager 530 may perform a set of traversals of the aerial path. In some examples, the position manager 530 may determine a height of the aerial position relative to the first surface region, where a thrust vector of the pressurized air stream is based on the height.

The debris manager 535 may displace debris from the first surface region to a second surface region using a pressurized air stream. In some examples, the debris manager 535 may direct a thrust from at least one rotor 540 toward the first surface region. In some cases, the first surface is co-planar with the second surface and where the first surface is adjacent to one or more vertical structures. In some cases, the first surface is vertically displaced from the second surface.

The rotor activator 525 may activate one or more rotors 540 of the aerial device based on the surface cleaning trigger. Rotor(s) 540 may represent components of device 505 that generate the aerodynamic lift force that supports the weight of device 505, the thrust that counteracts aerodynamic drag in forward flight, etc. Each rotor 540 may include one or more rotary wings or rotor blades that revolve around a mast. In some cases, rotor(s) 540 may generate a thrust vector that may be used for debris perturbation in accordance with aspects of the present disclosure.

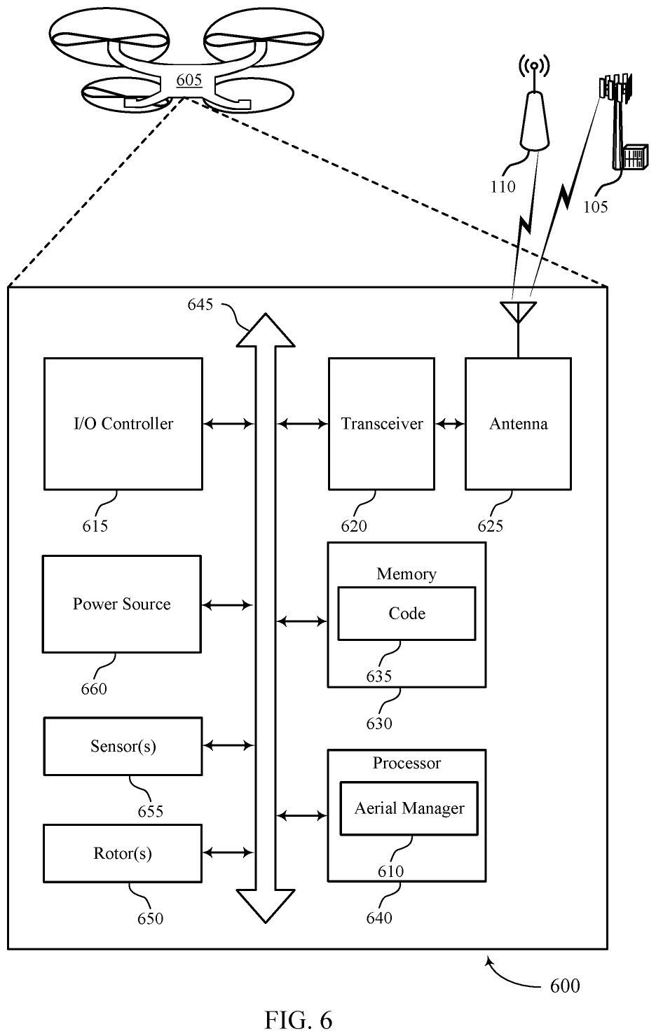

FIG. 6 shows a diagram of a system 600 including a device 605 that supports stair debris accumulation for automatic cleaning devices in accordance with aspects of the present disclosure. The device 605 may be an example of or include the components of a robotic device as described herein. The device 605 may include an aerial manager 610, an I/O controller 615, a transceiver 620, an antenna 625, memory 630, a processor 640, rotor(s) 650, sensor(s) 655, and a power source 660. These components may be in electronic communication via one or more buses (e.g., bus 645).

The device 605 may be an aerial robotic device that may include a number of rotors 650 operated by corresponding motors to provide locomotion and a frame. The frame may provide structural support for internal components (e.g., the I/O controller 615, the transceiver 620, the antenna 625, the memory 630, the processor 640, the sensor(s) 655, and the power source 660). For ease of description and illustration, some detailed aspects of the device 605 are omitted such as wiring, frame structure interconnects, or other features.

The aerial manager 610 may perform aspects of the operations described with reference to FIG. 5. For example, aerial manager 610 may identify a cleaning trigger for a first surface region. Aerial manager 610 may activate one or more rotors 650 of the aerial device based on the surface cleaning trigger. Aerial manager 610 may move to an aerial position proximal to the first surface region using the one or more rotors 650. Aerial manager 610 may displace debris from the first surface region to a second surface region using a pressurized air stream.

The I/O controller 615 may manage input and output signals for the device 605. The I/O controller 615 may also manage peripherals not integrated into the device 605. In some cases, the I/O controller 615 may represent a physical connection or port to an external peripheral. In some cases, the I/O controller 615 may utilize an operating system such as iOS®, ANDROID®, MS-DOS®, MS-WINDOWS®, OS/2®, UNIX®, LINUX®, or another known operating system. In other cases, the I/O controller 615 may represent or interact with a modem, a keyboard, a mouse, a touchscreen, or a similar device. In some cases, the I/O controller 615 may be implemented as part of a processor. In some cases, a user may interact with the device 605 via the I/O controller 615 or via hardware components controlled by the I/O controller 615.

The transceiver 620 may communicate bi-directionally, via one or more antennas, wired, or wireless links as described above. For example, the transceiver 620 may represent a wireless transceiver and may communicate bi-directionally with another wireless transceiver.

The transceiver 620 may also include a modem to modulate the packets and provide the modulated packets to the antennas for transmission, and to demodulate packets received from the antennas. In some cases, the wireless device may include a single antenna 625. However, in some cases the device may have more than one antenna 625, which may be capable of concurrently transmitting or receiving multiple wireless transmissions. For example, the device 605 may wirelessly communicate with access point 110 and/or base station 105 via the antenna 625, or another computing device (e.g., a beacon, a smartphone, a tablet, a robotic vacuum).

The memory 630 may include RAM and ROM. The memory 630 may store computer-readable, computer-executable code 635 including instructions that, when executed, cause the processor to perform various functions described herein. In some cases, the memory 630 may contain, among other things, a BIOS which may control basic hardware or software operation such as the interaction with peripheral components or devices.

The processor 640 may include an intelligent hardware device, (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 640 may be configured to operate a memory array using a memory controller. In other cases, a memory controller may be integrated into the processor 640. The processor 640 may be configured to execute computer-readable instructions stored in a memory (e.g., the memory 630) to cause the device 605 to perform various functions (e.g., functions or tasks supporting stair debris accumulation for automatic cleaning devices). The aerial manager 610 may be coupled to the processor 640. In some cases, the processor 640 (e.g., or the aerial manager 610) may include a maneuvering data component that is configured to provide travel control-related information such as orientation, attitude, speed, heading, and similar information that the aerial manager 610 may use for navigation purposes.

The code 635 may include instructions to implement aspects of the present disclosure, including instructions to support debris permutation. The code 635 may be stored in a non-transitory computer-readable medium such as system memory or other type of memory. In some cases, the code 635 may not be directly executable by the processor 640 but may cause a computer (e.g., when compiled and executed) to perform functions described herein.

The sensor(s) 655 may be one or more sensors configured to conduct periodic or ongoing automatic measurements related to autonomous functions (e.g., SLAM). A single sensor 655 may be capable of sensing multiple parameters (e.g., weight, airflow pressure, GPS), or alternatively, separate sensors may monitor separate resource parameters. For example, one sensor 655 may measure temperature, while another sensor 655 (or, in some cases, the same sensor 655) may determine orientation. In some cases, one or more sensors 655 may additionally monitor alternate sensor parameters, such as audio, vibrations, and the like.

In some examples, the sensor 655 be an example of an IMU or a similar sensor (e.g., accelerometer, a gyroscope, etc.). The processor 640 may receive additional information from one or more sensors 655 (e.g., an optical sensor, a pneumatic sensor that may sense reduced airflow or suction, a camera sensor that may be a monocular camera) and/or other sensors. In some examples, the sensor(s) 655 may include one or more optical sensors capable of detecting infrared, ultraviolet, and/or other wavelengths of light. The sensor(s) 655 may also include at least one sensor that provides motion feedback to the processor 640, for example, a rotor sensor (e.g., one or more wheel/rotary encoders), a contact or pressure sensor configured to provide a signal indicating contact with a surface, etc. The sensor(s) 655 may also include one or more of a radio frequency (RF) sensor, a barometer, a sonar emitter/detector, a radar emitter/detector, a microphone or another acoustic sensor, or another sensor that may provide information usable by the processor 640 for movement operations as well as navigation and positioning calculations.

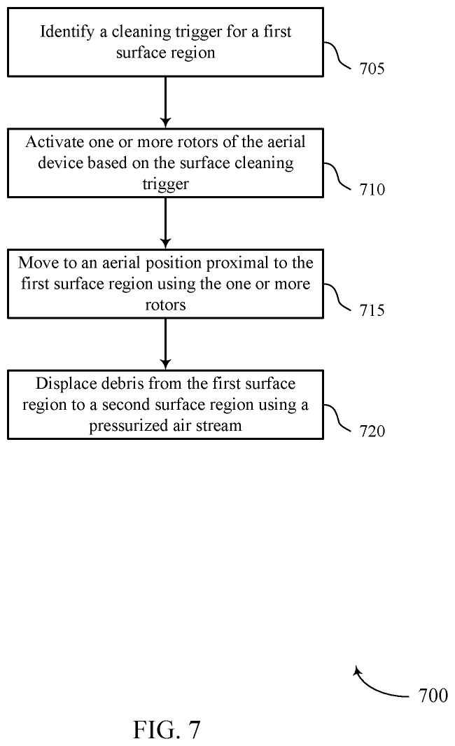

FIG. 7 shows a flowchart illustrating a method 700 that supports stair debris accumulation for automatic cleaning devices in accordance with aspects of the present disclosure. The operations of method 700 may be implemented by a device or its components as described herein. For example, the operations of method 700 may be performed by an aerial manager as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 705, the device may identify a cleaning trigger for a first surface region. The operations of 705 may be performed according to the methods described herein. In some examples, aspects of the operations of 705 may be performed by a trigger manager as described with reference to FIG. 5.

At 710, the device may activate one or more rotors of the aerial device based on the surface cleaning trigger. The operations of 710 may be performed according to the methods described herein. In some examples, aspects of the operations of 710 may be performed by a rotor activator as described with reference to FIG. 5.

At 715, the device may move to an aerial position proximal to the first surface region using the one or more rotors. The operations of 715 may be performed according to the methods described herein. In some examples, aspects of the operations of 715 may be performed by a position manager as described with reference to FIG. 5.

At 720, the device may displace debris from the first surface region to a second surface region using a pressurized air stream. The operations of 720 may be performed according to the methods described herein. In some examples, aspects of the operations of 720 may be performed by a debris manager as described with reference to FIG. 5.

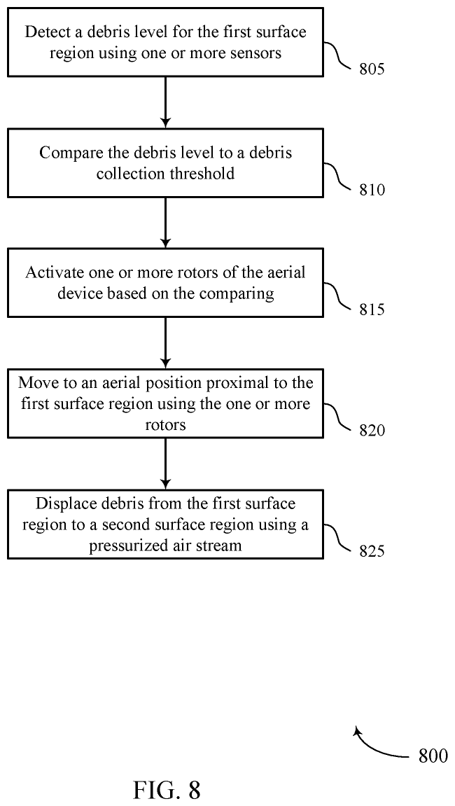

FIG. 8 shows a flowchart illustrating a method 800 that supports stair debris accumulation for automatic cleaning devices in accordance with aspects of the present disclosure. The operations of method 800 may be implemented by a device or its components as described herein. For example, the operations of method 800 may be performed by an aerial manager as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 805, the device may detect a debris level for the first surface region using one or more sensors. The operations of 805 may be performed according to the methods described herein. In some examples, aspects of the operations of 805 may be performed by a trigger manager as described with reference to FIG. 5.

At 810, the device may compare the debris level to a debris collection threshold. The operations of 810 may be performed according to the methods described herein. In some examples, aspects of the operations of 810 may be performed by a trigger manager as described with reference to FIG. 5.

At 815, the device may activate one or more rotors of the aerial device based on the comparing. The operations of 815 may be performed according to the methods described herein. In some examples, aspects of the operations of 815 may be performed by a rotor activator as described with reference to FIG. 5.

At 820, the device may move to an aerial position proximal to the first surface region using the one or more rotors. The operations of 820 may be performed according to the methods described herein. In some examples, aspects of the operations of 820 may be performed by a position manager as described with reference to FIG. 5.

At 825, the device may displace debris from the first surface region to a second surface region using a pressurized air stream. The operations of 825 may be performed according to the methods described herein. In some examples, aspects of the operations of 825 may be performed by a debris manager as described with reference to FIG. 5.

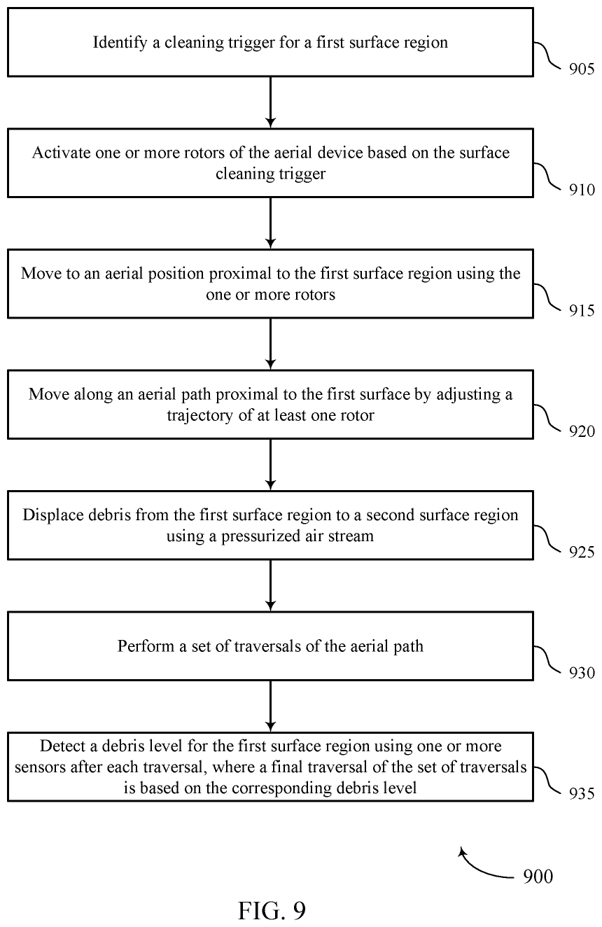

FIG. 9 shows a flowchart illustrating a method 900 that supports stair debris accumulation for automatic cleaning devices in accordance with aspects of the present disclosure. The operations of method 900 may be implemented by a device or its components as described herein. For example, the operations of method 900 may be performed by an aerial manager as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 905, the device may identify a cleaning trigger for a first surface region. The operations of 905 may be performed according to the methods described herein. In some examples, aspects of the operations of 905 may be performed by a trigger manager as described with reference to FIG. 5.

At 910, the device may activate one or more rotors of the aerial device based on the surface cleaning trigger. The operations of 910 may be performed according to the methods described herein. In some examples, aspects of the operations of 910 may be performed by a rotor activator as described with reference to FIG. 5.

At 915, the device may move to an aerial position proximal to the first surface region using the one or more rotors. The operations of 915 may be performed according to the methods described herein. In some examples, aspects of the operations of 915 may be performed by a position manager as described with reference to FIG. 5.

At 920, the device may move along an aerial path proximal to the first surface by adjusting a trajectory of at least one rotor. The operations of 920 may be performed according to the methods described herein. In some examples, aspects of the operations of 920 may be performed by a position manager as described with reference to FIG. 5.

At 925, the device may displace debris from the first surface region to a second surface region using a pressurized air stream. The operations of 925 may be performed according to the methods described herein. In some examples, aspects of the operations of 925 may be performed by a debris manager as described with reference to FIG. 5.

At 930, the device may perform a set of traversals of the aerial path. The operations of 930 may be performed according to the methods described herein. In some examples, aspects of the operations of 930 may be performed by a position manager as described with reference to FIG. 5.

At 935, the device may detect a debris level for the first surface region using one or more sensors after each traversal, where a final traversal of the set of traversals is based on the corresponding debris level. The operations of 935 may be performed according to the methods described herein. In some examples, aspects of the operations of 935 may be performed by a trigger manager as described with reference to FIG. 5.

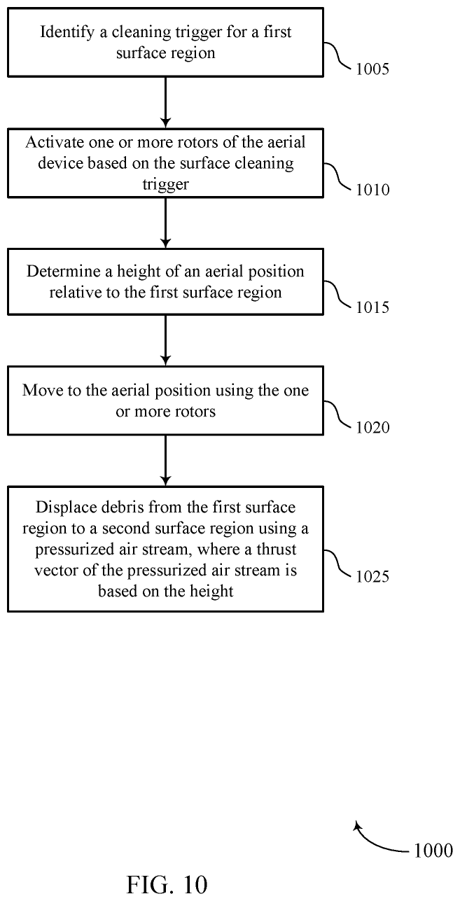

FIG. 10 shows a flowchart illustrating a method 1000 that supports stair debris accumulation for automatic cleaning devices in accordance with aspects of the present disclosure. The operations of method 1000 may be implemented by a device or its components as described herein. For example, the operations of method 1000 may be performed by an aerial manager as described with reference to FIGS. 5 and 6. In some examples, a device may execute a set of instructions to control the functional elements of the device to perform the functions described below. Additionally or alternatively, a device may perform aspects of the functions described below using special-purpose hardware.

At 1005, the device may identify a cleaning trigger for a first surface region. The operations of 1005 may be performed according to the methods described herein. In some examples, aspects of the operations of 1005 may be performed by a trigger manager as described with reference to FIG. 5.

At 1010, the device may activate one or more rotors of the aerial device based on the surface cleaning trigger. The operations of 1010 may be performed according to the methods described herein. In some examples, aspects of the operations of 1010 may be performed by a rotor activator as described with reference to FIG. 5.

At 1015, the device may determine a height of the aerial position relative to the first surface region. The operations of 1020 may be performed according to the methods described herein. In some examples, aspects of the operations of 1020 may be performed by a position manager as described with reference to FIG. 5.

At 1015, the device may move to an aerial position proximal to the first surface region using the one or more rotors. The operations of 1015 may be performed according to the methods described herein. In some examples, aspects of the operations of 1015 may be performed by a position manager as described with reference to FIG. 5.

At 1025, the device may displace debris from the first surface region to a second surface region using a pressurized air stream, where a thrust vector of the pressurized air stream is based on the height. The operations of 1025 may be performed according to the methods described herein. In some examples, aspects of the operations of 1025 may be performed by a debris manager as described with reference to FIG. 5.

It should be noted that the methods described above describe possible implementations, and that the operations and the steps may be rearranged or otherwise modified and that other implementations are possible. Further, aspects from two or more of the methods may be combined.

Information and signals described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The various illustrative blocks and modules described in connection with the disclosure herein may be implemented or performed with a general-purpose processor, a digital signal processor (DSP), an application-specific integrated circuit (ASIC), a field-programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described above can be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that can be accessed by a general purpose or special purpose computer. By way of example, and not limitation, non-transitory computer-readable media may include random-access memory (RAM), read-only memory (ROM), electrically erasable programmable read only memory (EEPROM), flash memory, compact disk (CD) ROM or other optical disk storage, magnetic disk storage or other magnetic storage devices, or any other non-transitory medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “exemplary” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, well-known structures and devices are shown in block diagram form in order to avoid obscuring the concepts of the described examples.

The description herein is provided to enable a person skilled in the art to make or use the disclosure. Various modifications to the disclosure will be readily apparent to those skilled in the art, and the generic principles defined herein may be applied to other variations without departing from the scope of the disclosure. Thus, the disclosure is not limited to the examples and designs described herein, but is to be accorded the broadest scope consistent with the principles and novel features disclosed herein.

What is claimed is:

1. A method for debris perturbation by an aerial device, comprising:
identifying a cleaning trigger for a first surface region;
activating one or more rotors of the aerial device based at least in part on the surface cleaning trigger;
moving to an aerial position proximal to the first surface region using the one or more rotors; and
displacing debris from the first surface region to a second surface region using a pressurized air stream.

2. The method of claim 1, wherein identifying the cleaning trigger for the first surface region comprises:
detecting a debris level for the first surface region using one or more sensors;
comparing the debris level to a debris collection threshold; and
activating the one or more rotors based at least in part on the comparing.

3. The method of claim 2, wherein the one or more sensors comprise a plurality of infrared beacons.

4. The method of claim 1, wherein moving to the aerial position proximal to the first surface region comprises:
moving along an aerial path proximal to the first surface region by adjusting a trajectory of at least one rotor.

5. The method of claim 4, further comprising:
performing a plurality of traversals of the aerial path; and
detecting a debris level for the first surface region using one or more sensors after each traversal, wherein a final traversal of the plurality of traversals is based at least in part on the corresponding debris level.

6. The method of claim 1, wherein displacing debris from the first surface region using the pressurized air stream comprises:
directing a thrust from at least one rotor toward the first surface region.

7. The method of claim 1, further comprising:
determining a height of the aerial position relative to the first surface region, wherein a thrust vector of the pressurized air stream is based at least in part on the height.

8. The method of claim 1, wherein identifying the cleaning trigger for the first surface region comprises:
identifying an activation interval corresponding to a periodic activation schedule.

9. The method of claim 1, wherein identifying the cleaning trigger for the first surface region comprises:
receiving an activation signal from another device.

10. The method of claim 1, wherein the first surface region is co-planar with the second surface region and wherein the first surface is adjacent to one or more vertical structures.

11. The method of claim 1, wherein the first surface region is vertically displaced from the second surface.

12. An apparatus for debris perturbation, comprising:
a processor,
memory in electronic communication with the processor; and
instructions stored in the memory and executable by the processor to cause the apparatus to:
identify a cleaning trigger for a first surface region;
activate one or more rotors of the apparatus based at least in part on the surface cleaning trigger;
move to an aerial position proximal to the first surface region using the one or more rotors; and
displace debris from the first surface region to a second surface region using a pressurized air stream.

13. The apparatus of claim 12, wherein the instructions to identify the cleaning trigger for the first surface region are executable by the processor to cause the apparatus to:
detect a debris level for the first surface region using one or more sensors;
compare the debris level to a debris collection threshold; and
activate the one or more rotors based at least in part on the comparing.

14. The apparatus of claim 12, wherein the instructions to displace debris from the first surface region using the pressurized air stream are executable by the processor to cause the apparatus to:
direct a thrust from at least one rotor toward the first surface region.

15. The apparatus of claim 12, wherein the instructions are further executable by the processor to cause the apparatus to:
determine a height of the aerial position relative to the first surface region, wherein a thrust vector of the pressurized air stream is based at least in part on the height.

16. An apparatus for debris perturbation, comprising:
means for identifying a cleaning trigger for a first surface region;
means for activating one or more rotors of the apparatus based at least in part on the surface cleaning trigger;
means for moving to an aerial position proximal to the first surface region; and
means for displacing debris from the first surface region to a second surface region.

17. The apparatus of claim 16, wherein the means for identifying the cleaning trigger for the first surface region comprises:
means for detecting a debris level for the first surface region;
means for comparing the debris level to a debris collection threshold; and
means for activating the one or more rotors based at least in part on the comparing.

18. The apparatus of claim 16, wherein the means for displacing debris from the first surface region comprises:
means for directing a thrust from at least one rotor toward the first surface region.

19. The apparatus of claim 16, further comprising:
means for determining a height of the aerial position relative to the first surface region, wherein a thrust vector of a pressurized air stream is based at least in part on the height.

20. The apparatus of claim 16, wherein the means for identifying the cleaning trigger for the first surface region comprises:
means for receiving an activation signal from another device.
